(19) United States
(12) Patent Application Publication
(10) Pub. No.: US 2007/0229368 A1
(43) Pub. Date: Oct. 4, 2007

(54) Planar coupler and integrated antenna system

(76) Inventors: Hiroshi Hata, Nagano (JP); Takahisa Karakama, Nagano (JP)

Correspondence Address: FLYNN THIEL BOUTELL & TANIS, P.C., 2026 RAMBLING ROAD, KALAMAZOO, MI, 49008-1631, US

(21) Appl. No.: 11/807,692

(22) Filed: May 30, 2007

Related U.S. Application Data
(63) Continuation-in-part of application No. 11/661,488.

(30) Foreign Application Priority Data
Aug. 27, 2004 (JP) 2004-247822

(51) Int. Cl. H01Q 1/38

(52) U.S. Cl. 343/700 MS; 343/850

(57) ABSTRACT

In a RF coupler that has high transmission efficiency in a broad range and that uses an RF printed layered circuit board, strong electrostatic coupling is obtained between circuits, and electromagnetic coupling is also used; C-shaped loops (1, 2) that have parts cut out face the surfaces of a dielectric plate having a thickness t; terminals (1a, 1b) connected to the two ends of the loop (1) are used as primary terminals; terminals (2a, 2b) of the loop (2) are used as secondary terminals; and coplanar lines (4) extend from these terminals along the surface of the dielectric plate up to terminals (41, 42). Therefore, the portions where the loops overlap are couplers, the coplanar lines are secondary transmission lines, and a wide variety of antennas not limited to dipoles may be connected to terminals (4a, 4b).

### CROSS-REFERENCE TO RELATED APPLICATIONS

This application is a continuation-in-part of co-pending U.S. patent application Ser. No. 11/661,488, filed Feb. 27, 2007, which is incorporated herein in its entirety.

### TECHNICAL FIELD

The present invention relates to a transformer or a coupler for coupling two or more high-frequency transmission circuits having different properties, and to an integrated antenna system.

### BACKGROUND ART

Inputs and outputs of electronic circuits for handling high-frequency (RF) signals are often unbalanced transmission lines that are grounded on one side. Therefore, unbalanced coaxial lines or microstrip lines are used for transmission cables that are directly connected to terminals of the inputs and outputs. In contrast, dipole antennas, loop antennas, and other balanced antennas, which are essential elements, are often used. Therefore, a balun (one type of an RF transformer) is needed for such connections.

In prior art, transformers in which a copper wire is wrapped around a binocular-shaped ferrite core as shown in FIG. 2A are used for coupling in the reception of television broadcasts and the like. Also, lumped parameter elements such as coils (whose induction is denoted by L) or capacitors (whose capacitance is denoted by C) are not readily applicable for the microwave band, which has a short wavelength. However, when the wavelength (hereinafter denoted as λ) is short, and a relatively small-sized balun can therefore be made using a distributed parameter circuit, the most uncomplicated balun has the configuration in FIG. 2B, wherein a ferrite core is not used. In any case, the balanced line and the unbalanced line are merely magnetically coupled (mutual induction denoted by M), and an equivalent circuit is as shown in FIG. 2C. Each of these has three-dimensional structures and is not originally designed to be integrated with an antenna or other adjacent element or adjacent transmission line.

In contrast, there is a trend towards the use of planarly configured antennas and baluns in recent television bands (UHF). Using a planar configuration will provide a reduction in cost resulting from integration, and is therefore advantageous. For example, such a planar configuration is disclosed in the below-described Patent Document 1. The coupler thereof has a coplanar structure as shown in FIG. 3, and this structure is readily manufactured.

[Patent Document 1] Japanese Patent No. 3323442

### DISCLOSURE OF THE INVENTION

However, in a planar configuration in which an antenna and a balun are formed in the same plane, sufficient electrical coupling cannot be produced in the coupling between the balanced line and unbalanced line.

It is an object of the present invention to resolve the stated problems with conventional baluns and other such linear couplers.

Specifically, it is an object of the present invention to provide a method for fashioning a coupler into a planar shape to achieve the following objects in an entire antenna/transmission system:

(1) Lower weight, smaller size

(2) Reduced production costs

(3) Improvements in transmission characteristics (reduced insertion loss, widened operation frequency range)

### MEANS USED TO SOLVE THE ABOVEMENTIONED PROBLEMS

In order to resolve the foregoing problems, the present invention is applied to an extremely thin double-sided RF printed circuit board which comprises a dielectric plate, a C-shaped primary loop (a planar conductor primary loop pattern that has a part cut out) located on the electronic-circuit side and formed on a first surface (front surface) of the dielectric plate, and a C-shaped secondary loop (a planar conductor secondary loop pattern that has a part cut out) located on the load or antenna side and formed as same size and same shape as the primary loop on a second surface (rear surface) of the dielectric plate; wherein these loops are disposed on both sides of the dielectric plate and face each other, except cut out portion. So they are coupled together not only inductively but also capacitively when the cut out portions are connected to external circuits as terminals.

The present invention also provides a planar antenna system obtained by forming a planar antenna pattern on the second conductor surface of the double-sided board.

The planar coupler can also have a multi-layered structure. In this case, the new coupler comprises a planar coupler mentioned in the above paragraph 0008, and for example one single-sided board (hereinafter referred to as a second board) on which a conductor planar tertiary loop pattern (hereinafter referred to as a C-shaped tertiary loop) having a part cut out, are formed as same size and same shape as those of the primary and secondary loops, on an external surface of the second board, wherein each circuit port (terminal) is kept off because only the faced portions have large capacitive and inductive coupling.

As a result, in this case it is apparent that a planar antenna system for two band operation can be obtained by forming antenna patterns on the terminals at each distal end of the extended coplanar lines formed on the two external surfaces.

The relationships of the C-shaped primary loop, secondary loop, and tertiary loop to the ground are determined independently according to the external lines to which they are connected. The coupler functions as a balun when the external lines contain one or more each of unbalanced lines and balanced lines.

### EFFECTS OF THE INVENTION

In the present invention, a thin double-sided printed circuit board is essentially used (or additional one or more single sided boards are necessary for over three port circuit) as a substrate, whereby size and weight can be reduced. The balun or another such transformer or coupler is integrated with adjacent transmission line or transmission line elements, whereby a dramatic reduction in manufacturing costs can be achieved.

Insertion loss can be improved by dispensing with the use of ferrite cores used in conventional products, and by using a thin board having low RF loss. The bandwidth can be increased by making loops having a size and shape designed for the selected thin board, and layering the loops precisely. Accordingly, the transmission characteristics can be markedly improved.

Specifically, the effects achieved with the present invention are exhibited in a variety of transmission lines and adjacent elements that operate linearly in VHF, UHF, and SHF frequency ranges. In the microwave band, there are isolators, circulators, and other components that have traditionally employed the anisotropy of ferrite or the like. There are also many components that employ only the low loss and high permeability of ferrite, such as with RF transformers. So, the use of ferrite has been forced despite the fact that the latter preferably needs an inherently linear operation. Therefore, many components such as baluns, branching filters, and other couplers could not be operated in large-amplitude circumstances (in nonlinear operation), and have had a three-dimensional structure. However, with the recent emergence of thin high-quality RF boards, planar loops can be brought sufficiently close together, whereby satisfactory magnetic coupling M can be obtained without the use of ferrite. In addition, the thinness of the looped circuit board results in sufficient capacitance C at high frequencies. Therefore, by disposing the loops so as to constitute the equivalent circuit described later and shown in FIG. 4, a planar coupler became possible to have enough capacitive and inductive coupling.

### BRIEF DESCRIPTION OF THE DRAWINGS

FIG. 1 is a transparent view of an entire coupler joined to a dielectric plate in which only the conductor portion and the edges of the dielectric plate are visible. In this figure, only the scale of thickness direction have been enlarged, and the secondary planar transmission line is integrated with a planar capacitance/dielectric coupler provided with a primary power supply terminal according to the present invention;

FIG. 2A is a descriptive view showing a ferrite core that is widely used in baluns, multiplexers, branching filters, and other connection circuit components that are normally directly below the antenna to receive VHF and UHF surface wave television broadcasts; FIG. 2B is a descriptive view showing a split-slot-form balun between a microwave measuring dipole or loop antenna and a coaxial line; and FIG. 2C shows a common equivalent circuit of FIG. 2B and a BALUN using ferrite core showed in FIG. 2A;

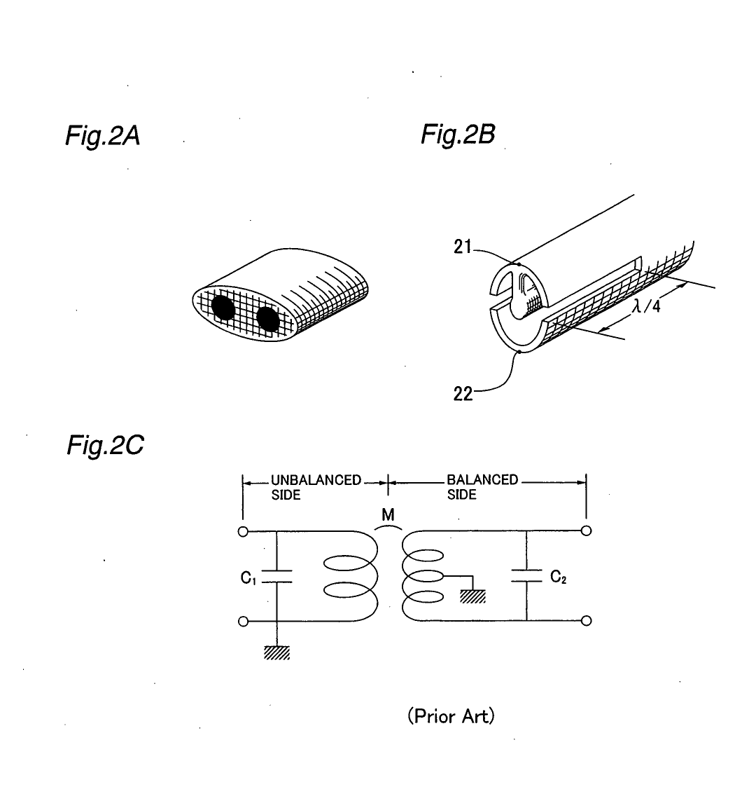

FIG. 3 is a descriptive view showing a conventional one-surface capacitance coupling balun;

FIG. 4A is an equivalent circuit diagram, based on a lumped parameter, of the coupling portion in FIG. 1 in a case in which an unbalanced line is connected to the primary loop and a balanced line is externally connected to the secondary loop; and FIG. 4B is an equivalent circuit diagram during matching in FIG. 4A when a capacitive coupling wave source and an inductive coupling wave source are regarded as a secondary balanced-system equivalent wave source; and

FIG. 5 shows a transparent view of an example of a multi-layered planar capacitive/inductive coupler, in which an unbalanced line is connected on the primary side of the coupler shown in FIG. 1, wherein the secondary and tertiary loop terminals each have two balanced-system lines and accordingly the planar coupler operates as a 3-port-balun.

### SYMBOLS

1 C-shaped primary loop conductor of the coupler
1a, 1b Terminals of the C-shaped loop
2 C-shaped secondary loop conductor of the coupler
2a, 2b Terminals of the C-shaped loop
3 Additional conductor of a coupler of a 3 port-balun
3a, 3b Terminals of the C-shaped tertiary loop
4 Coplanar line
4a, 4b Load-side terminals (Antenna-side terminals)
5 Load of the secondary transmission line (for example, antenna)
x, y, z Coordinates for representing the directions of the three-dimensional structure
0 Origin (x=0, y=0, z=0)
P Center of the secondary loop (x=−t, y=0, z=0)
Q Center of the tertiary loop (x=t, y=0, z=0)
t Thickness of the dielectric plate
C, C1, C2 Capacity of the capacitors
L₁, L₂ Self inductance of the coils in the equivalent circuit or C-shaped loops
M Mutual inductance between the coils in the equivalent circuit or mutual inductance between the C-shaped loops
Z₀₁, Z₀₂ Characteristic impedance of the transmission circuit on the primary side and secondary side
Z₁, Z₂ Input impedance of the circuit on the primary side and secondary side
R₁, R₂ Resistance of the abovementioned circuits (during matching)
\dot{E}_{0C} (ω) Secondary-side equivalent electromotive force resulting from capacitive coupling (Vector representation)
\dot{E}_{0M} (ω) Secondary-side equivalent electromotive power resulting from inductive coupling (Vector representation)
ω angular frequency of the electromagnetic waves
λ Free-space wave length of electromagnetic wave

### BEST MODE FOR CARRYING OUT THE INVENTION

The present invention shall be described below with reference to the drawings.

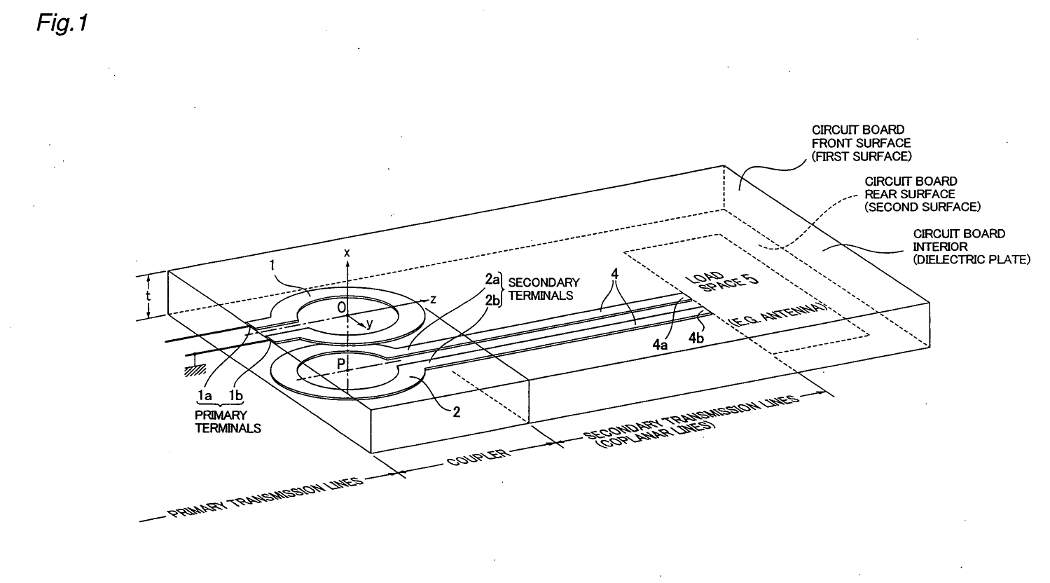

The following is a description, made with reference to FIG. 1, of the principle of the operation of the coupler, which is the basis of the present invention. In FIG. 1, circular loops 1, 2 having parts cut out (C-shaped primary loop and secondary loop patterns) are formed at the same positions but in opposite direction on the front and rear surfaces of a double-sided conductive foil printed circuit board (hereinafter referred to as double sided board). The circular loops 1, 2 thereby face each other across a dielectric plate (illustrated as being transparent for the sake of convenience in the description) having a thickness t. Terminals 1a, 1b of the cut portions of the loop 1 are primary loop terminals, and the same portions 2a, 2b of the loop 2 are secondary loop terminals, from which coplanar lines 4 extend in the Z direction up to terminals 4a, 4b. This configuration is an example of the simplest coupler configuration, wherein the portion where the two loops overlap is the coupler, and the coplanar lines are secondary transmission lines. Therefore, for example, when a coaxial cable is connected to the terminals 1a, 1b; and a balanced antenna such as a dipole is connected to the terminals 4a, 4b; and this coupler can operate as a balun.

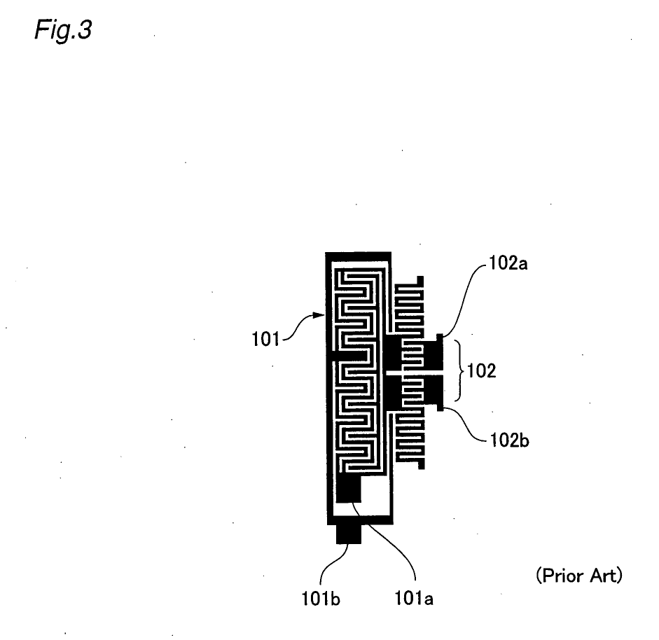

Inter-loop capacitance C and mutual induction M will increase as long as the thickness t of the dielectric body has sufficiently been reduced. As a result, a much greater capacitance coupling can be generated than when the patterns are formed on the same plane as in the conventional configuration shown in FIG. 3. Ferrite is not used to generate magnetic induction coupling, but since the gap t is small, there is little magnetic flux leakage, and the coupling strength is similar to cases in which ferrite is used.

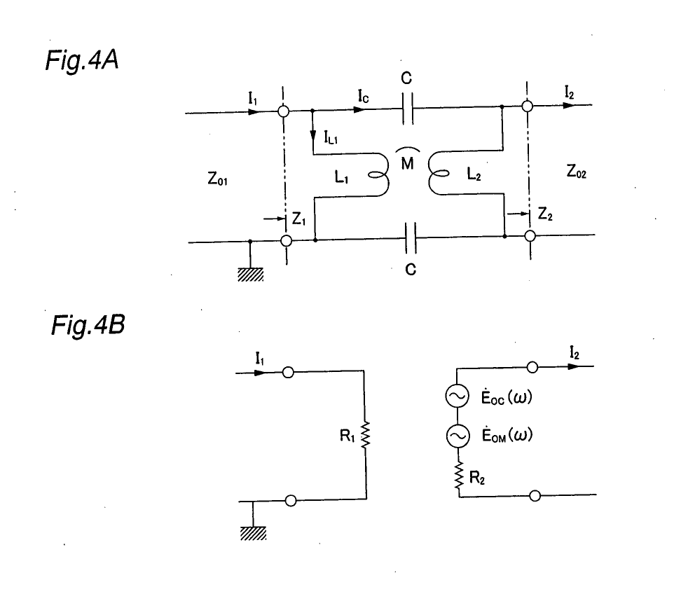

FIG. 4A shows the equivalent circuit of the coupler (coupler portion) using lumped parameter along with the characteristic impedance Z₀₁, Z₀₂ of the circuits that are connected on the right and left. At first glance, the circuit appears to be a high-pass filter, but the ratio between RF currents I_{L1} and I_{C} changes in accordance with angular frequency ω. Therefore, the broadband characteristics and separation band characteristics can be expected by suitably selecting a crossover frequency f_{C} with the M coupling.

FIG. 4B is an equivalent circuit having RF signal sources diagram during matching performed when the equivalent wave source is considered for the secondary circuit. \dot{E}_{0C} is the capacitive coupling electromotive force, and \dot{E}_{0M} is the inductive coupling electromotive force. These are both functions of the angular frequency ω. \dot{E}_{0C} (ω) is effective at high frequencies in the pass band, and \dot{E}_{0M} (ω) is dominant at low frequencies. The electromotive forces function so that the vector sum thereof is as shown in the following equation.
\dot{E}₀(ω)=\dot{E}_{0C}(ω)+\dot{E}_{0M}(ω)

Strictly speaking, the equivalent circuit itself is thus not expressed by a lumped parameter, and must be treated as a distributed parameter circuit.

The coupler shown in FIG. 1 is a representative example of a balun, corresponding to cases in which coaxial lines are connected to the primary side and a balanced antenna is connected to the secondary side. For example, when the external sides of the loops are annular in shape and have a diameter of about 30 mm, and a double-sided printed board having a thickness t of about 0.3 mm is used, this coupler can be used as a balun for UHF band television broadcasting. In this instance, it is necessary to match the characteristic impedance of the coplanar line 4 with the input impedance of the antenna 5 and to suitably set the length of the coplanar line.

Even when the antenna is not connected to the terminals 4a, 4b, if the length of the coplanar line 4 and other factors are suitably set, it became applicable as a flask-shaped indoor television reception antenna without further alteration.

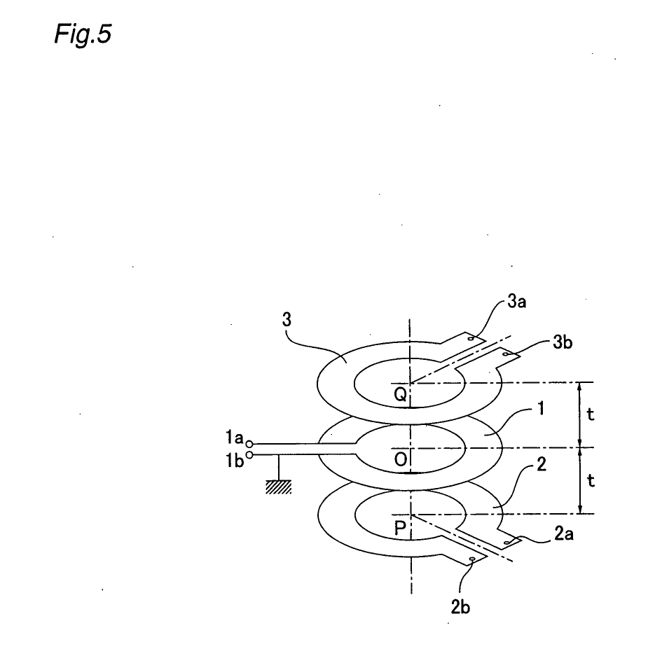

FIG. 5 shows an example in which there are three layered circular couplers and two openings in the load side. The terminals 2a, 2b and 3a, 3b can be freely designed otherwise, and therefore can be used to connect two antennas or loads having different frequency bands and input impedances.

In a multi-layered structure having three or more layers, the circuits are often all balanced or unbalanced. However, this selection is determined solely by the grounding of external components connected to the circuit board, and therefore the coupler itself can be shared in all instances.

1. A planar coupler comprising:
a RF double-sided conductive foil printed circuit board (hereinafter referred to as a double-sided board);
a conductor planar primary loop pattern (hereinafter referred to as a C-shaped primary loop) that is formed on a first conductor surface of the double-sided board and that has a part cut out;
a conductor planar secondary loop pattern (hereinafter referred to as a C-shaped secondary loop) that is formed on a second conductor surface of the double-sided board and that has a part cut out; wherein
the C-shaped primary and C-shaped secondary loops are disposed so as to face each other across a dielectric plate that is a middle layer of the double-sided board, and are coupled together by capacitive coupling and inductive coupling.

2. An antenna system comprising:
a planar coupler according to claim 1; and
an antenna pattern formed on the second conductor surface of the double-sided board.

3. A planar coupler comprising:
a planar coupler according to claim 1; and
a at least one RF single-sided conductive foil circuit board (hereinafter referred to as a single-sided board) superposed on the planner coupler in a manner that a conductor surface thereof (hereinafter referred to as a third conductor surface) faces outside and opposite to the planar coupler, wherein
the third conductor surface is formed thereon with a conductor planar loop (hereinafter referred to as a C-shaped tertiary loop) that has a same shape and same size as those of the C-shaped first or second loop, and wherein
the C-shaped tertiary loop and the C-shaped first or second loop are faced each other across a dielectric plate that is a middle layer of the single-sided board, and are coupled together by capacitive coupling and inductive coupling.

4. An antenna system comprising:
a planar coupler according to claim 3;
a first antenna pattern formed on the second conductor surface of the double-sided board; and
a second antenna pattern formed on the third conductor surface of the single-sided board.
